(19) United States
(12) Patent Application Publication
(10) Pub. No.: US 2016/0135465 A1
(43) Pub. Date: May 19, 2016

(54) Building Materials Having Antifungal Properties

(71) Applicant: ARCH CHEMICALS INC., Allendale, NJ (US)

(72) Inventors: George Polson, Jasper, GA (US); Craog Waldron, Marietta, GA (US); Jody Jourden, Alpharetta, GA (US); Zheng Qi, Alpharetta, GA (US); Xiao Jiang, Montvale, NJ (US); Brittany Lizon, Alpharetta, GA (US); Leon Estell, Alpharetta, GA (US); Patrick Flaherty, Alpharetta, GA (US)

(73) Assignee: Arch Chemicals, Inc., Allendale, NJ (US)

(21) Appl. No.: 14/899,803

(22) PCT Filed: Jun. 19, 2014
(86) PCT No.: PCT/US2014/043070

§ 371 Date: Dec. 18, 2015

Related U.S. Application Data
(60) Provisional application No. 61/837,532, filed on Jun. 20, 2013.

(51) Int. Cl. A01N 55/02; E04C 2/26; E04B 1/64; E04C 2/30; C04B 22/14; E04B 1/92

(52) U.S. Cl. CPC A01N 55/02; C04B 22/143; E04B 1/92; E04B 1/64; E04C 2/30; E04C 2/26

(57) ABSTRACT

Building material products, particularly wallboard, are disclosed that are mold resistant. A mold inhibitory composition is contained in one component of the building material product. The mold inhibitory composition comprises a pyrithione in combination with at least one potentiator. The potentiator can comprise a metal chelate, a membrane permeabilizer, or another microorganism weakening agent.

### RELATED APPLICATIONS

The present application is based upon and claims priority to U.S. Provisional Patent Application Ser. No. 61/837,532, filed on Jun. 20, 2013, which is incorporated herein by reference.

### BACKGROUND

One of the most common ways of constructing walls and barriers includes the use of inorganic wallboard panels or sheets, such as gypsum wallboard, often referred to simply as “wallboard” or “drywall.” Wallboard can be formulated for interior, exterior, and wet applications. The use of wallboard, as opposed to conventional wet plaster methods, is often desirable because the installation of wallboard is ordinarily less costly than installation of conventional plaster walls.

Generally, wallboard is conventionally produced by enclosing a core of an aqueous slurry of calcined gypsum and other materials between two large sheets of board cover paper. Various types of cover paper are known in the art, as are other types of facing materials. After the gypsum slurry has set (i.e., reacted with the water from the aqueous slurry) and dried, the sheet is cut into standard sizes.

Many building material products such as wallboard are well suited for absorbing moisture. For instance, moisture can be absorbed by the facing materials and can also be absorbed by the core material of wallboard. Moisture can be absorbed by these materials especially in high humidity environments, such as in bathrooms and basements. These building material products can also become wet due to accidental spills or due to leaks in the plumbing or leaks in the exterior of the building. Unfortunately, even small amounts of moisture can stimulate the growth of many mold organisms. Some mold organisms are sporulating fungal organisms that, when they mature, spew out allergenic matter that can detrimentally affect indoor air quality. Consequently, when mold infestation occurs in a building or home, the owners typically have to tear down walls and replace with new materials.

Various different anti-mold agents have been developed in the past and incorporated into building material products, such as wallboards. For instance, in the past, pyrithione has been used to prevent mold growth on or in wallboards. For instance, mold-resistant wallboards are disclosed in U.S. Patent Publication No. 2006/0171976, in U.S. Patent Publication No. 2007/0082170 and in U.S. Pat. No. 6,893,752, which are all incorporated herein by reference.

Although the use of pyrithione has made great advances in the art in producing wallboards that are resistant to mold growth, further improvements are still needed. For instance, pyrithione is not completely effective in preventing sporulating fungal organisms and/or pyrithione may tend to decrease in activity over time. Consequently, the present disclosure is directed to further improvements in producing building material products, such as wallboard, that are mold resistant.

### SUMMARY

The present disclosure is generally directed to a mold inhibitory composition for use in building material products that contains a pyrithione in combination with one or more potentiators. According to the present disclosure, certain species can act as potentiators for pyrithione in building material products, such as wallboard, rendering the pyrithione not only more effective, but can also prolong the efficacy of pyrithione.

In one embodiment, the present disclosure is directed to a building material product. The building material product includes a core that is comprised of gypsum. The core includes a first face and a second and opposite face. At least one facing layer is adhered to the first face, to the second face, or to both the first face and the second face of the core. The facing layer may comprise a pulp fiber substrate, such as a paper substrate. In accordance with the present disclosure, the building material product further includes a mold inhibiting composition. The mold inhibiting composition is contained in at least one facing layer, in the core, or in both the core and the facing layers. The mold inhibitory composition includes an antimicrobial comprising a pyrithione. The mold inhibiting composition further comprises a potentiator. The potentiator improves the effectiveness of the antimicrobial.

The potentiator may comprise any suitable compound capable of increasing the efficacy of the pyrithione. The potentiator, for instance, may comprise a metal chelator, a long chain aliphatic amine, an amine oxide surfactant, or mixtures thereof. In one embodiment, the potentiator comprises tropolone or a tropolone complex, such as a zinc tropolone complex. In an alternative embodiment, the potentiator may comprise a copper salt such as a copper amine salt. The copper salt, for instance, may comprise copper ethanolamine.

In still another embodiment, the potentiator may comprise oleylamine or dodecylamine. In still another embodiment, the potentiator may comprise a metal salt chelate of dehydroacetic acid. For instance, the potentiator may comprise a zinc salt of dehydroacetic acid.

The pyrithione present in the building material product may comprise a metal pyrithione such as zinc pyrithione, sodium pyrithione, or mixtures thereof.

The pyrithione may be in the form of particles, particularly small particles. For instance, 100% of the particles may have a particle size of less than 5 microns, while at least 50%, such as at least 70% of the particles have a particle size of less than 1 micron.

In an alternative embodiment, a liquid pyrithione may be used.

The pyrithione may be present in one component of the building material product at a concentration of from about 50 ppm to about 10,000 ppm, such as from about 100 ppm to about 5,000 ppm, such as from about 500 ppm to about 3,500 ppm. The molar ratio of the potentiator to the pyrithione may be from about 0.5:1 to about 10:1, such as from about 1:1 to about 5:1, such as from about 2:1 to about 3:1.

Building material products, such as wallboard, treated in accordance with the present disclosure can have excellent mold-resistant properties. For instance, when tested according to ASTM Test D3273, wallboards treated in accordance with the present disclosure can have a rating of greater than 7, such as greater than 8, such as greater than 9, and can even have a rating of 10.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

Building materials, such as wallboards, are currently treated with a pyrithione complex. The pyrithione complex may be contained in the core and also in the facing layer made from paper. Although pyrithione has excellent anti-mold properties, pyrithione alone, in some embodiments, is incapable of meeting current ASTM guidelines for the evaluation of anti-fungal wallboards, especially according to ASTM Test D3273. In this regard, the present disclosure is directed to a mold inhibitory composition for building material products that is more potent than many past formulations. In accordance with the present disclosure, the mold inhibitory composition comprises a pyrithione combined with at least one potentiator, thereby rendering the pyrithione more effective and/or having prolonged efficacy. The potentiator may comprise an amine, a metal chelator, such as an iron chelator or a copper chelator, copper salts, surfactants, natural extracts, and the like.

Pyrithione, such as pyrithione complexes, are good antimicrobial agents. Over time, however, microorganisms are capable of detoxifying pyrithione. The present disclosure is directed to include a potentiator with the pyrithione in order to minimize detoxification. For example, metals, such as iron, can be essential nutrients for many microorganisms, such as molds. In one embodiment, the potentiator comprises a compound capable of sequestering iron around or inside any microorganisms present in the environment. Using a metal chelator, such as an iron chelator, can make the organisms, such as mold, weaker and hence more vulnerable to pyrithione.

In an alternative embodiment, a membrane permeabilizer may be combined with pyrithione for weakening the microorganisms for enhancing the activity of the antimicrobial. One embodiment of a membrane permeabilizer, for instance, is a long chain amine, such as a long chain aliphatic amine.

A mold inhibitory composition made in accordance with the present disclosure may be incorporated into any suitable building product, such as wallboard. The combination of an antimicrobial and a potentiator, when applied to gypsum or a facing layer covering the gypsum, is able to inhibit the growth of mold organisms for a prolonged period of time. Of particular advantage, when tested according to ASTM Test D3270, the mold inhibitory composition of the present disclosure is capable of demonstrating efficacy to obtain a score greater than 7, such as greater than 8, such as greater than 9, such as even a score of 10 where no visible growth of mold is observed even when the wallboard product is subjected to a humid environment.

As described above, wallboard is conventionally produced by enclosing a core of an aqueous slurry of calcined gypsum and other components between one or more facing layers. The facing layer may comprise different materials. In one embodiment, the facing layer contains pulp fibers. In this regard, the facing layer may comprise a paper, such as a paperboard. In an alternative embodiment, the facing layer may comprise starch or a starch layer. In another embodiment, starch may be used to attach a pulp containing facing layer to the core material.

The slurry used to make the core of wallboard comprises calcined gypsum alone or in combination with various other materials. In one embodiment, for instance, the core may further include filler materials, binders, and the like.

Gypsum is typically obtained naturally from gypsum rock. The gypsum rock is ground to a desired fineness and then undergoes calcination. Calcination is performed by heating the gypsum rock in order to remove moisture and produce calcium sulfate hemihydrate. Calcium sulfate hemihydrate, when mixed with water, will set and form the core material.

When producing wallboard, an aqueous slurry of calcined gypsum and other components can be continuously deposited between two facing layers. The slurry can contain any calcined gypsum including calcium sulfate hemihydrate, calcium sulfate anhydrite or both. Calcium sulfate hemihydrate can produce at least two crystal forms, the alpha and beta forms. Beta or alpha calcium sulfate hemihydrate may be used.

In some embodiments, additives are included in the gypsum slurry to modify one or more properties of the final product. Such additives can include starches, defoamers, surfactants, dispersants and the like. Such additives can include naphthalene sulfonates and wax emulsions. A set accelerator may also be present comprising calcium sulfate dihydrate co-ground with sugar and heated to 250° F. (121° C.) to caramelize the sugar.

A trimetaphosphate compound can be added to the gypsum slurry in some embodiments to enhance the strength of the product and to reduce sag of the set gypsum. Preferably the concentration of the trimetaphosphate compound is from about 0.1% to about 2.0% based on the weight of the calcined gypsum. Exemplary trimetaphosphate salts include sodium, potassium or lithium salts of trimelaphosphate.

In addition, the gypsum composition optionally can include a starch, such as a pregelatinized starch or an acid-modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). The pregelatinized starch can be added to the mixture used to form the set gypsum composition such that it is present in an amount of from about 0.5% to about 10% percent by weight of the set gypsum composition.

Gypsum panels are typically greater than ⅛ inch in thickness. The gypsum panels can be from about ⅜ inch (9.5 mm) to about 2 inches (51 mm), from about ¾ inch (19 mm) to about 1¼ inch (32 mm) or from about 1/2 inch (13 mm) to about 1 inch (25 mm) in thickness.

In accordance with the present disclosure, a mold inhibitory composition may be applied to the aqueous slurry that produces the core of the wallboard, may be applied to one of the facing layers, may be applied to both facing layers, or may be applied to both the facing layers and the core. In accordance with the present disclosure, the mold inhibitory composition generally comprises a pyrithione combined with one or more potentiators. As used herein, a pyrithione includes pyrithione salts, and particularly polyvalent metal salts of pyrithione. For instance, pyrithione salts can be formed from polyvalent metals such as magnesium, barium, bismuth, strontium, copper, zinc, cadmium, zirconium and mixtures thereof.

Pyrithione is known by several names, including 2 mercaptopyridine-N-oxide; 2-pyridinethiol-1-oxide (CAS Registry No. 1121-31-9); 1-hydroxypyridine-2-thione and 1 hydroxy-2(1H)-pyridinethione (CAS Registry No. 1121-30-8). The sodium derivative (C₅H₄ NOSNa) is known as sodium pyrithione (CAS Registry No. 3811-73-2). Pyrithione salts are commercially available from Arch Chemicals, Inc., such as Sodium OMADINE or Zinc OMADINE.

The pyrithione may be added to the building material product in different forms. In one embodiment, for instance, the pyrithione may comprise an aqueous dispersion, such as an aqueous dispersion containing zinc pyrithione. The pyrithione may be contained in the aqueous dispersion as particles, and particularly small particles. For instance, the particles can have a particle size such that 100% of the particles have a particle size of less than about 5 microns and at least about 50% of the particles, such as at least about 70% of the particles have a particle size of 1 micron or less. Particle size can be measured using a laser scattering particle size analyzer, such as a HORIBA LA 910 particle size analyzer.

The particles can be present in the aqueous dispersion in an amount greater than about 30% by weight and in an amount less than about 70% by weight. In one embodiment, for instance, the particles are present in an amount from about 40% to about 60% by weight. The aqueous dispersion can also contain various other components, such as a dispersant and/or a viscosity control agent. The pH of the aqueous dispersion can be from about 6.5 to about 8.5. In an alternative embodiment, the pH can be greater such as from about 9 to about 11 depending upon the ingredients contained in the dispersion.

In an alternative embodiment, the pyrithione may be added to the building material product as a solution. For instance, the solution may contain sodium pyrithione. The solution may contain pyrithione in an amount greater than about 25% by weight, such as from about 30% by weight to about 70% by weight. In one embodiment, for instance, the solution can contain pyrithione in an amount from about 35% by weight to about 45% by weight. The solution can have a pH of from about 8.5 to about 10.5 and can contain various other components in addition to the pyrithione and water. For instance, in one embodiment, the solution can contain an amine, which may increase the pH to from about 11 to about 12.

The pyrithione is added to the building material product in an amount sufficient to inhibit the growth of microorganisms, particularly mold. As mentioned above, the pyrithione can be added to the core and/or one or more facing layers of wallboard. The concentration of pyrithione added to a component of the wallboard can depend upon various different factors. In general, pyrithione is added at a concentration of greater than about 50 ppm and up to a concentration of about 10,000 ppm. More particularly, the pyrithione concentration is generally greater than about 100 ppm, such as greater than about 200 ppm, such as greater than about 300 ppm, such as greater than about 400 ppm, such as greater than about 500 ppm. The concentration is generally less than about 5,000 ppm, such as less than about 3,500 ppm, such as less than about 2,000 ppm. In one embodiment, the concentration of pyrithione in one component of the wallboard can be from about 100 ppm to about 5,000 ppm, such as from about 500 ppm to about 3,500 ppm.

In accordance with the present disclosure, the mold inhibitory composition, in addition to a pyrithione, also contains one or more potentiators. As used herein, a potentiator is any compound, ion, element, oligomer, or polymer that is capable of increasing the efficacy of the pyrithione. In accordance with the present disclosure, the potentiator may comprise, for instance, a metal chelator, a metal salt which may or may not be a metal chelator, a long chain aliphatic amine, a natural extract, and the like.

The amount a particular potentiator is present in the mold inhibitory composition can depend upon various factors including the type of potentiator that is used, the type of pyrithione that is used, and the possible presence of other potentiators. In general, each potentiator can be present in relation to pyrithione at a molar ratio of from about 0.5:1 to about 10:1, such as from about 1:1 to about 5:1, and particularly from about 2:1 to about 3:1.

As described above, one potentiator that may be used in accordance with the present disclosure is a long chain amine, and particularly a long chain, aliphatic amine. The long chain amine, in one embodiment, can be a primary amine. The amine can also be unsaturated. For instance, the long chain amine may include one or more carbon double bonds.

In general, the long chain aliphatic amine can have a carbon chain length from about 12 carbon atoms to about 60 carbon atoms, such as from about 12 carbon atoms to about 40 carbon atoms, such as from about 12 carbon atoms to about 28 carbon atoms. Examples of long chain aliphatic amines that may be used in accordance with the present disclosure include oleylamine, dodecylamine, or mixtures thereof.

In an alternative embodiment, the potentiator may comprise an enolic ketone, such as an unsaturated enolic ketone. An example of an enolic ketone is tropolone. For example, in one embodiment, a tropolone complex may be used as a potentiator. The tropolone complex may comprise a metal complex, such as a complex with zinc or copper. Tropolone can be synthetically made or can be obtained naturally from cedar wood.

In another embodiment of the present disclosure, a copper salt is used as a potentiator, such as a copper amine. For instance, in one embodiment, the potentiator comprises copper ethanolamine.

In still another embodiment, the potentiator may comprise a metal salt of dehydroacetic acid (DHA). For instance, in one embodiment, the potentiator comprises a zinc salt chelate of DHA.

In still another embodiment, the potentiator may also comprise a surfactant. For instance, an amine oxide surfactant may be used, such as a cocamine oxide surfactant. In one particular embodiment, the surfactant comprises N-alkyl(C₁₂-C₁₆)dimethylamine oxides.

The present disclosure may be better understood with reference to the following examples.

### EXAMPLES

Pyrithione was combined with various potentiators and added to wallboard samples for mold testing according to ASTM Test D3273. ASTM Test D3273 evaluates the relative resistance of wallboard to surface fungi growth in a severe interior environment for a four-week period.

A facing layer made of paper attached to a wallboard panel was treated with various different formulations. The determined dosing level for the paper treatment was 2,000 ppm active. The potentiators were added at a molar ratio of 3:1 for samples containing zinc pyrithione and at a molar ratio of 2:1 for samples containing sodium pyrithione.

The following samples were tested:

TABLE 1

| | | | Active | Potentiator |
|---|---|---|---|---|
| | | Molar | (ppm | (ppm on |
| Formula | Potentiator | Eq | on paper) | paper) |
| Zinc | — | — | 2000 | — |
| Pyrithione | Oleylamine | 3x | 2000 | 5226 |
| 48 wt. % | Dodecylamine | 3x | 2000 | 3484 |
| dispersion | Tropolone-Zn | 3x | 2000 | 5806 |
| | Zinc salt of | 3x | 2000 | 7548 |
| | dehydroacetic acid | | | |
| | Copper Ethanolamine | 3x | 2000 | 1200 |
| | N-Alkyl(C₁₂₋₁₆) | 3x | 2000 | 4335 |
| | dimethylamine oxides | | | |
| Zinc | — | — | 2000 | — |
| Pyrithione | Oleylamine | 3x | 2000 | 5226 |
| 37 wt. % | Dodecylamine | 3x | 2000 | 3484 |
| dispersion | Tropolone-Zn | 3x | 2000 | 5806 |
| | Zinc salt of | 3x | 2000 | 7548 |
| | dehydroacetic acid | | | |
| | Copper Ethanolamine | 3x | 2000 | 1200 |
| | N-Alkyl(C₁₂₋₁₆) | 3x | 2000 | 4335 |
| | dimethylamine oxides | | | |
| Sodium | — | — | 2000 | — |
| Pyrithione | Oleylamine | 2x | 2000 | 7419 |
| 40% | Dodecylamine | 2x | 2000 | 4968 |
| solution | Tropolone-Zn | 2x | 2000 | 8258 |
| | Zinc salt of | 2x | 2000 | 10710 |
| | dehydroacetic acid | | | |
| | Copper Ethanolamine | 2x | 2000 | 1703 |
| | N-Alkyl(C₁₂₋₁₆) | | | |
| | dimethylamine oxides | 2x | 2000 | 6155 |
| Sodium | — | — | 2000 | — |
| Pyrithione | Oleylamine | 2x | 2000 | 7419 |
| 10% | Dodecylamine | 2x | 2000 | 4968 |
| solution | Tropolone-Zn | 2x | 2000 | 8258 |
| | Zinc salt of | 2x | 2000 | 10710 |
| | dehydroacetic acid | | | |
| | Copper Ethanolamine | 2x | 2000 | 1703 |
| | N-Alkyl(C₁₂₋₁₆) | 2x | 2000 | 6155 |
| | dimethylamine oxides | | | |
| Zinc | — | — | 2000 | — |
| Pyrithione | | | | |
| 40% | | | | |
| solution | | | | |
| Control | — | — | — | — |

The samples were tested using ASTM D3273-12 “Standard Test Method for Resistance to Growth of Mold on the Surface Interior Coatings in an Environmental Chamber.” Standard protocol for the method was followed using the following fungal strains: Aspergillus niger (ATCC 6275); Penicillium citrinum (ATCC 9849); Aureobasidium pullulans (ATCC 9348).

Fungal cultures were obtained from GTS Microbiology Lab culture collection. Suspensions containing fungal hyphae and spores were prepared for each organism and combined in equal volumes for the inocula. Inocula was dispensed via pipet over the soil surface of environmental chamber and allowed to incubate at 33° C. After three weeks of conditioning incubation, two plates of Potato Dextrose Agar (PDA) were exposed in the chamber for one hour as a validity check. These plates were incubated for one week and demonstrated sufficient sporulation in the chamber before exposing wallboard samples to the chamber.

The wallboard samples were suspended over the inoculated soil to incubate for four weeks. The treated faces of the samples were examined visually and with stereo microscope. The fungal growth on wallboard panel was rated according to the scales described in the ASTM D3273 method after four weeks of incubation with indirect inoculation of fungal spores.

The results for ASTM D3273 test are shown in Table 2 below. Following are the rating scales used for individual panel rating. The adjusted average ratings were the average of valid wallboard panels.
10=0 to <1% defacement
9=1 to 10% defacement
8=11 to 20% defacement
7=21 to 30% defacement
6=31 to 40% defacement
5=41 to 50% defacement
4=51 to 60% defacement
3=61 to 70% defacement
2=71 to 80% defacement
1=81 to 90% defacement
0=91 to 100% defacement

The untreated control wallboard had an average rating 2.0, which validated this study by demonstrating a sever fungi growth on untreated wallboard in the conditioned environment chamber.

TABLE 2

| | | Adjusted |
|---|---|---|
| Formula | Potentiator | Average Rating |
| Zinc | — | 9.3 |
| Pyrithione | Oleylamine | 9.3 |
| 48 wt. % | Dodecylamine | 9.5 |
| dispersion | Tropolone-Zn | 9.0 |
| | Zinc salt of dehydroacetic acid | 10.0 |
| | Copper Ethanolamine | 9.0 |
| | N-Alkyl(C₁₂₋₁₆)dimethylamine | 9.0 |
| | oxides | |
| Zinc | — | 9.3 |
| Pyrithione | Oleylamine | 9.0 |
| 37 wt. % | Dodecylamine | 9.7 |
| dispersion | Tropolone-Zn | 9.0 |
| | Zinc salt of dehydroacetic acid | 10.0 |
| | Copper Ethanolamine | 8.7 |
| | N-Alkyl(C₁₂₋₁₆)dimethylamine | 9.5 |
| | oxides | |
| Sodium | — | 8.0 |
| Pyrithione | Oleylamine | 7.3 |
| 40% solution | Dodecylamine | 7.0 |
| | Tropolone-Zn | 8.7 |
| | Zinc salt of dehydroacetic acid | 9.7 |
| | Copper Ethanolamine | 9.3 |
| | N-Alkyl(C₁₂₋₁₆)dimethylamine | 8.0 |
| | oxides | |
| Sodium | — | 1.7 |
| Pyrithione | Oleylamine | 1.3 |
| 10% solution | Dodecylamine | 1.5 |
| | Tropolone-Zn | 5.3 |
| | Zinc salt of dehydroacetic acid | 3.7 |
| | Copper Ethanolamine | 4.5 |
| | N-Alkyl(C₁₂₋₁₆)dimethylamine | 1.0 |
| | oxides | |
| Sodium | — | 9.5 |
| Pyrithione | | |
| 40% solution | | |
| Control | — | 2.0 |

As shown above, each of the potentiators tested showed the ability to enhance anti-mold activity.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A building material product comprising:
a core comprising gypsum, the core including a first face and a second and opposite face;
at least one facing layer adhered to the first face, the second face or both the first face and the second face of the core; and
a mold-inhibiting composition contained in the building material product, the mold-inhibitory composition including an antimicrobial comprising a pyrithione, the mold-inhibiting composition further comprising a potentiator for the pyrithione.

2. A building material product as defined in claim 1, wherein the potentiator comprises a metal chelator.

3. A budding material product as defined in claim 1, wherein the potentiator comprises a long chain aliphatic amine.

4. A building material product as defined in claim 1, wherein the potentiator comprises a tropolone.

5. A building material product as defined in claim 1, wherein the potentiator comprises a copper salt.

6. A building material product as defined in claim 5, wherein the copper salt comprises copper ethanolamine.

7. A building material product as defined in claim 1, wherein the potentiator comprises an amine oxide surfactant.

8. A building material product as defined in claim 1, wherein the potentiator comprises oleylamine, dodecylamine, or mixtures thereof.

9. A building material product as defined in claim 1, wherein the potentiator comprises a dehydroacetic acid.

10. A building material product as defined in claim 1, wherein the pyrithione comprises zinc pyrithione, the pyrithione being present in the building material product as particles, and wherein 100% of the zinc pyrithione particles have a particle size of less than 5 microns and wherein at least 50% of the zinc pyrithione particles, have a particle size of less than 1 micron.

11. A building material product as defined in claim 1, wherein the pyrithione comprises a sodium pyrithione.

12. A building material product as defined in claim 1, wherein the mold inhibitory composition is contained in the facing layer.

13. A building material product as defined in claim 1, wherein the mold inhibitory composition is contained in the core.

14. A building material product as defined in claim 1, wherein the mold inhibitory composition is contained in the facing layer and in the core.

15. A building material product as defined in claim 1, wherein the mold inhibitory composition contains more than one potentiator.

16. A building material product as defined in claim 1, wherein the antimicrobial is present in a component of the building material product at a concentration of from about 50 ppm to about 10,000 ppm.

17. A building material product as defined in claim 1, wherein the molar ratio of the potentiator to pyrithione is from about 0.5:1 to about 10:1.

18. A building material product as defined in claim 4, wherein the tropolone comprises a metal tropolone complex.

19. A building material product as defined in claim 9, wherein the dehydroacetic acid comprises a dehydroacetic acid metal salt.

20. A building material product as defined in claim 1, wherein the potentiator comprises a metal chelator complex.

21. A mold-inhibiting composition for incorporation into a building material product comprising:
an antimicrobial comprising pyrithione, and a potentiator for the pyrithione, the potentiator comprising a tropolone, a copper amine salt, a metal salt of dehydroacetic acid, or mixtures thereof.
